(19) United States
(12) Patent Application Publication
(10) Pub. No.: US 2005/0267922 A1
(43) Pub. Date: Dec. 1, 2005

(54) Apparatus, method, and program for image display

(75) Inventors: Kazuki Nakajima, Tokyo (JP); Toshihiko Kaku, Kanagawa-ken (JP); Fumihiro Sonoda, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/139,583

(22) Filed: May 31, 2005

(30) Foreign Application Priority Data
May 28, 2004 (JP) 159649/2004

(51) Int. Cl. G06F 17/30

(52) U.S. Cl. 707/204; 707/1

(57) ABSTRACT

Backup of image data sets is carried out with ease. For this purpose, the image data sets are stored in image storage means. The image storage means may comprise a plurality of recording media or an external apparatus. When the image data sets stored in the image storage means are displayed, a degree of security is calculated for the image data sets according to reliability of backup locations of the image data sets and the number of the backup locations, for example. The degree of security is displayed in a visually perceptible manner. For example, in the case where the degree is low for one of the image data sets, a red or yellow frame is added to the corresponding image according to the degree of security thereof.

### BACKGROUND OF THE INVENTION

1. Field of the Invention

The present invention relates to an image display apparatus and an image display method for displaying stored images or file names thereof. The present invention also relates to a program for causing a computer to execute the image display method.

2. Description of the Related Art

A method of storing image data sets and reproducing the image data sets has been proposed. In this method, image data sets are obtained by a digital camera or by reading images recorded on a negative film or prints with a scanner or the like. The image data sets are stored in an image reproduction apparatus such as a personal computer, and reproduced in the form of a slide show. By storing image data sets in an HDD recorder or the like, a slide show can also be reproduced on a TV set connected to the HDD recorder.

When such image data sets are stored, the image data sets need to be backed up to prevent of data destruction or loss thereof caused by a failure of a hard disc, for example. It is also desirable for the image data sets to be managed in a decentralized manner, to prepare for natural disasters such as earthquakes.

For this reason, image data sets stored in a hard disc of a personal computer are backed up in a recording medium such as a DVD or an MO disc. Alternatively, the image data sets are backed up by being sent from the personal computer to an external file server connected to a network. In addition, a RAID may be configured by a plurality of hard discs so that image data sets can be backed up through generation of copies of the image data sets in each of the hard discs.

Since a backup operation of image data sets is a time-consuming operation, many users do not back up their image data sets. Even if a user does back up his/her image data sets, regular backup thereof is a troublesome operation.

Therefore, a system for easy management of data such as backup has been proposed in Japanese Unexamined Patent Publication No. 10(1998)-011336. In this system, an electronic warehouse and an electronic library are installed by being connected to a personal computer of a user via a network, and data sets are stored in the electronic warehouse. Some of the data set in the electronic warehouse that are not accessed frequently are moved to the electronic library and stored with version management. A file collection car in the form of a data packet is sent from the electronic warehouse or the electronic library to the personal computer of the user, and the file collection car causes a file list stored in the electronic warehouse or library to be displayed on the personal computer. By specifying data sets to be sent to the electronic warehouse, some of the data sets stored in the electronic warehouse but to be deleted therefrom, and the data sets to be moved to the electronic library in response to the display, the data sets can be stored, deleted, moved, and borrowed. In this manner, data management such as backup can be carried out easily.

Such image data sets can be secured against destruction or loss thereof, as the number of locations to store the same image data sets increases. Furthermore, image data sets are more secured against destruction or loss thereof if the image data sets are stored in a more reliable server. Therefore, image data sets can be backed up more easily if security of the image data sets can be understood upon display of the image data sets stored in a personal computer or the like.

### SUMMARY OF THE INVENTION

The present invention has been conceived based on consideration of the above circumstances. An object of the present invention is therefore to enable easier backup of image data sets.

An image display apparatus of the present invention comprises:
image storage means for storing images;
backup processing means for carrying out backup processing regarding the images; and
display control means for finding a degree of security regarding the stored images according to a degree of backup thereof and for displaying the images or file names thereof on display means in such a manner that the degree of security is visually perceptible.

The images may be displayed on the display means one by one, or as a catalog of thumbnail images generated from the images.

Displaying the degree of security in a visually perceptible manner refers to displaying the degree of security in such a manner that the degree can be understood by viewing the images or the file names thereof. More specifically, the degree of security can be displayed in a visually perceptible manner in the form of numerals or by addition of frames having colors corresponding to the degree of security to the images, for example.

In the image display apparatus of the present invention, the image storage means may comprise a plurality of recording media so that the backup processing means can carry out the backup processing by storing the images in each of the recording media.

The plurality of recording media may comprise recording media of the same type or different types. For example, in the case where the recording media are hard discs and the image storage means comprises the hard discs of the same type, the image storage means forms a RAID. In the case where the image storage means comprises recording media of two types, one of the types may be a hard disc while the other is a recordable DVD.

In the image display apparatus of the present invention, the backup processing means may carry out the backup processing by sending the stored images to at least one external apparatus.

Furthermore, in the image display apparatus of the present invention, the display control means may find the degree of security according to reliability of backup locations of the images and according to the number of the backup locations.

An image display method of the present invention is an image display method for an image display apparatus having image storage means for storing images and backup processing means for carrying out backup processing regarding the images, and the method comprises the steps of:
finding a degree of security for the stored images according to a degree of backup of the images; and
displaying the images or file names thereof in such a manner that the degree of security is visually perceptible.

The image display method of the present invention may be provided as a program for causing a computer to execute the image display method.

According to the present invention, the degree of security can be found based on the degree of backup of the images that have been stored, and the images or the file names thereof are displayed in the manner that the degree of security is visually perceptible. Therefore, a user viewing the images or the file names thereof can easily understand the degree of security. Consequently, the user can easily understand which of the images needs to be backed up in priority. In this manner, the user can easily back up the images.

Furthermore, if the image storage means comprises recording media and if the backup processing is carried out by storing the images in each of the recording media, the image display apparatus can solely back up the images.

By backing up the images through transmission thereof to the external apparatus or apparatuses, the images can be more secured against destruction or loss thereof.

In addition, by finding the degree of security according to the reliability of where the images are backed up and how many locations the images are backed up in, the degree of security can be found easily.

Note that the program of the present invention may be provided being recorded on a computer readable medium. Those who are skilled in the art would know that computer readable media are not limited to any specific type of device, and include, but are not limited to: CD's, RAM's ROM's, hard disks, magnetic tapes, and internet downloads, in which computer instructions can be stored and/or transmitted. Transmission of the computer instructions through a network or through wireless transmission means is also within the scope of this invention. Additionally, the computer instructions include, but are not limited to: source, object, and executable code, and can be in any language, including higher level languages, assembly language, and machine language.

### BRIEF DESCRIPTION OF THE DRAWINGS

FIG. 1 is a block diagram showing the configuration of an image backup system using an HDD recorder adopting an image display apparatus of the present invention;

FIG. 2 is a block diagram showing the configuration of the HDD recorder;

FIG. 3 shows an example of a backup list;

FIG. 4 is a flow chart showing a procedure carried out at the time of display of a catalog of thumbnail images;

FIG. 5 shows a screen in which the catalog of the thumbnail images is displayed; and

FIG. 6 is a block diagram showing the configuration of anther image backup system using the HDD recorder adopting the image display apparatus of the present invention.

### DESCRIPTION OF THE PREFERRED EMBODIMENT

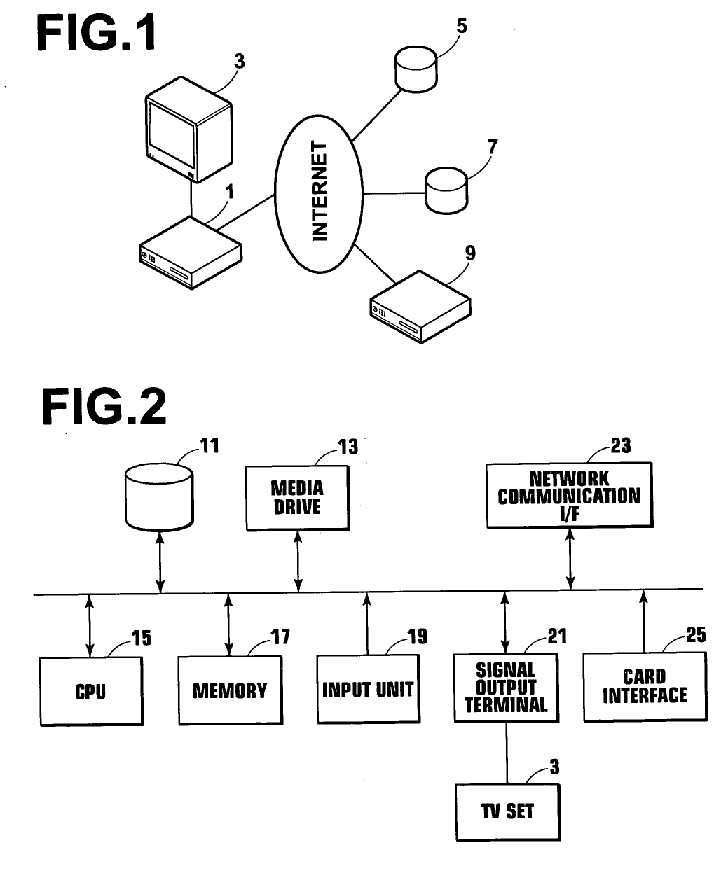

Hereinafter, an embodiment of the present invention will be described with reference to the accompanying drawings. FIG. 1 is a block diagram showing the configuration of an image backup system using an HDD recorder adopting an image display apparatus of the present invention. As shown in FIG. 1, the image backup system in this embodiment comprises an HDD recorder 1, a TV set 3 connected to the HDD recorder 1, file servers 5 and 7 connected to the HDD recorder 1 via the Internet, and another HDD recorder 9.

FIG. 2 is a block diagram showing the configuration of the HDD recorder 1. As shown in FIG. 2, the HDD recorder 1 comprises a RAID 11, a media drive 13, a CPU 15, a memory 17, and an input unit 19. The RAID 11 comprises a plurality of HDDs (2 HDDs in this embodiment) for storing image data sets and moving image data sets that have been recorded. The media drive 13 records the image data sets and the moving image data sets in a recordable recording medium such as a DVD-R, and reads image data sets and moving image data sets recorded in a recording medium. The CPU 15 controls the entire HDD recorder 1, and carries out various kinds of control such as recording control regarding the image data sets and the moving image data sets, communication control, and display control. The memory 17 comprises an area storing software such as an operation program for the CPU 15 and various constants, and a workspace used by the CPU 15. The input unit 19 is used by a user for inputting various kinds of instructions to the HDD recorder 1.

The HDD recorder 1 also has a signal output terminal 21 for outputting an audio signal and a video signal to the TV set 3, a network communication interface 23 connected to the Internet, and a card interface 25 for reading image data sets and moving image data sets (hereinafter collectively referred to as the image data sets) from a memory card.

By having the configuration described above, the HDD recorder 1 can read the image data sets from the memory card (not shown) by using the card interface 25, and can store the image data sets in the RAID 11. In this embodiment, the RAID 11 has the two HDDs, and the same image data sets are stored in the two HDDs by causing the two HDDs to synchronize.

The HDD recorder 1 can also store the image data sets in the file server 5 or 7 or both of the servers (hereinafter referred to as the file servers 5 and 7), by sending the image data sets thereto through connection to the Internet via the network communication interface 23. The HDD recorder 1 can also store the image data sets in the HDD recorder 9 by sending the image data sets thereto.

More specifically, a catalog of the image data sets stored in the RAID 11 is shown on the TV set 3, and some of the image data sets selected by the user from the catalog with use of the input unit 19 are sent to the file servers 5 and/or 7 and/or to the HDD 9. In this manner, the image data sets selected by the user from the image data sets stored in the RAID 11 can be backed up. The image data sets stored in the RAID 11 can be backed up in the file servers 5 and 7 and/or the HDD 9 by causing the image data sets to synchronize with the image data sets stored in the file servers 5 and 7 and/or the HDD recorder 9. In this case, the image data sets in the RAID 11 are the same as the image data sets in the servers 5 and 7 and/or the HDD 9.

By using the HDD 9 owned by a family member or a friend of the user, the image data sets can be backed up by being provided to the family member or the friend.

Where the image data sets are backed up may be registered in advance so that a list thereof can be displayed on the TV set 3. In this case, the user selects where to back up.

In this embodiment, the file server 5 has been installed by a reliable manufacturer, and can be used by the user for a charge. The user can use the file server 7 for free.

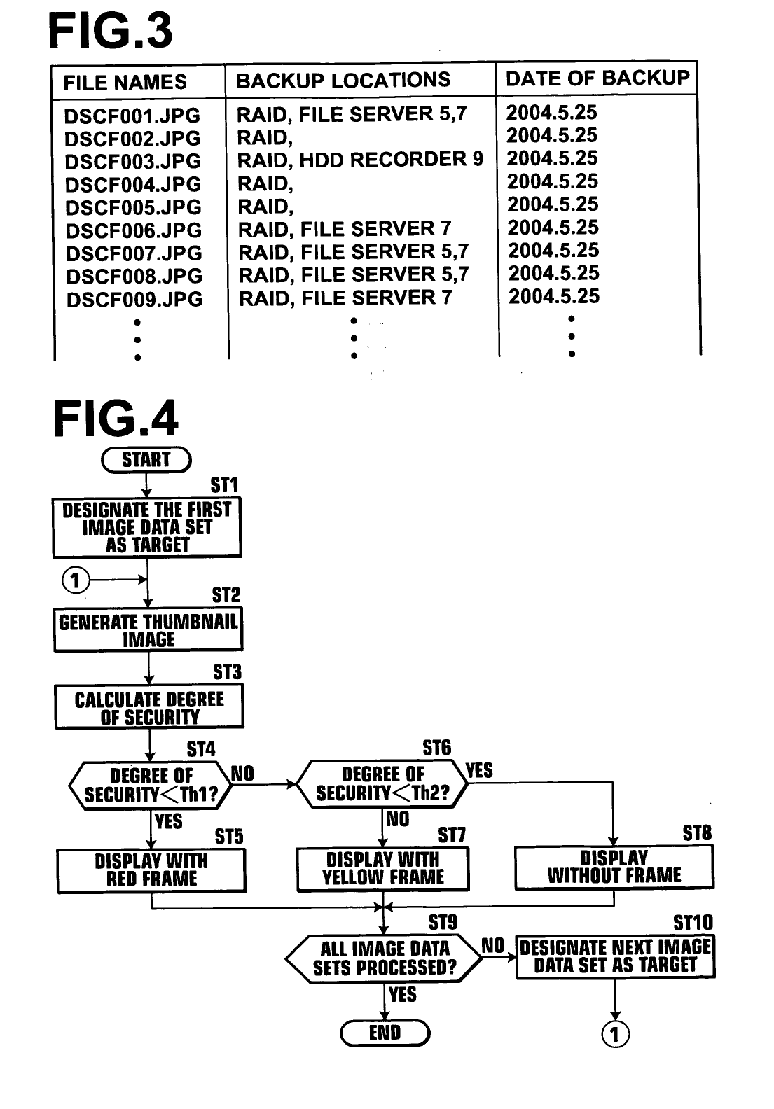

A state of backup of the image data sets stored in the RAID 11 is stored in the RAID 11 in the form of a backup list. FIG. 3 shows an example of the backup list. As shown in FIG. 3, the backup list has items of file names of the image data sets, backup locations thereof, and date of backup. Since all of the image data sets are backed up in the RAID 11 as shown in FIG. 3, “RAID” is described in the item of backup locations. For the image data sets backed up in the file servers 5 and 7 by the user, “File Server 5” and “File Server 7” are also described in the item of backup locations. For the image data sets backed up in the HDD recorder 9, “HDD Recorder 9” is described in the item of backup locations.

A procedure will be described next for display of the catalog of the thumbnail images regarding the image data sets stored in the RAID 11. FIG. 4 is a flow chart showing the procedure carried out at the time of display of the catalog. The procedure is started when the user inputs an instruction to the HDD 1 to display the catalog by using the input unit 19. The CPU 15 designates the image data set having the first file name in alphanumeric order as a target to be processed (Step ST1). The CPU 15 generates a thumbnail image data set representing a thumbnail image by reducing a size of the image represented by the target image data set (Step ST2), and calculates a degree of security of the target image data set with reference to the backup list (Step ST3).

In this embodiment, the backup locations can be the RAID 11, the file servers 5 and 7, and the HDD recorder 9, and reliability thereof is set therefor. More specifically, the reliability is 1 for the RAID 11, the file server 7, and the HDD recorder 9 while the reliability of the file server 5 is 3. The CPU 15 searches for the backup locations of the target image data set with reference to the backup list. The CPU 15 then calculates the degree of security according to Equation (1) below:
degree of security=(sum of the reliability of all of the backup locations)×(the number of the backup locations) (1)

For example, for the image data set whose file name is DSCF001.JPG, the backup locations thereof are the RAID 11 and the file servers 5 and 7. Therefore, the degree of security thereof becomes (1+3+1)×3=15. Likewise, the degree of security is calculated as 1, 4, 1, 1, 4, 15, 15, and 4 for the image data sets whose file names are DSCF002.JPG through DSCF009.JPG, for example.

The CPU 15 then judges whether the calculated degree is smaller than a predetermined threshold value Th1 (Step ST4). If a result at Step ST4 is affirmative (that is, the degree is smaller than Th1), a red frame is added to the thumbnail image of the target image data set, which is then displayed on the TV set 3 (Step ST5). The threshold value Th1 may be 2, for example.

If the result at ST4 is negative (that is, the degree is not smaller than Th1), the CPU 15 further judges whether the degree is smaller than a predetermined threshold value Th2 that is larger than the threshold value Th1 (Step ST6). The threshold value Th2 may be 5, for example. If a result at ST6 is affirmative (that is, the degree is smaller than Th2), a yellow frame is added to the thumbnail image of the target image data set, which is then displayed on the TV set 3 (Step ST7).

If the result at ST6 is negative (that is, the degree is not smaller than Th2), the thumbnail image of the target image data set is displayed on the TV set 3 without a frame added thereto (Step ST8).

The CPU 15 then judges whether all of the image data sets have been processed (Step ST9). If a result at Step ST9 is negative, the CPU 15 designates the next image data set as the target image data set (Step ST10), and the procedure returns to Step ST2. If the result at ST9 is affirmative, the procedure ends. In this manner, the catalog of the thumbnail images of the image data sets stored in the RAID 11 is shown on the TV set 3.

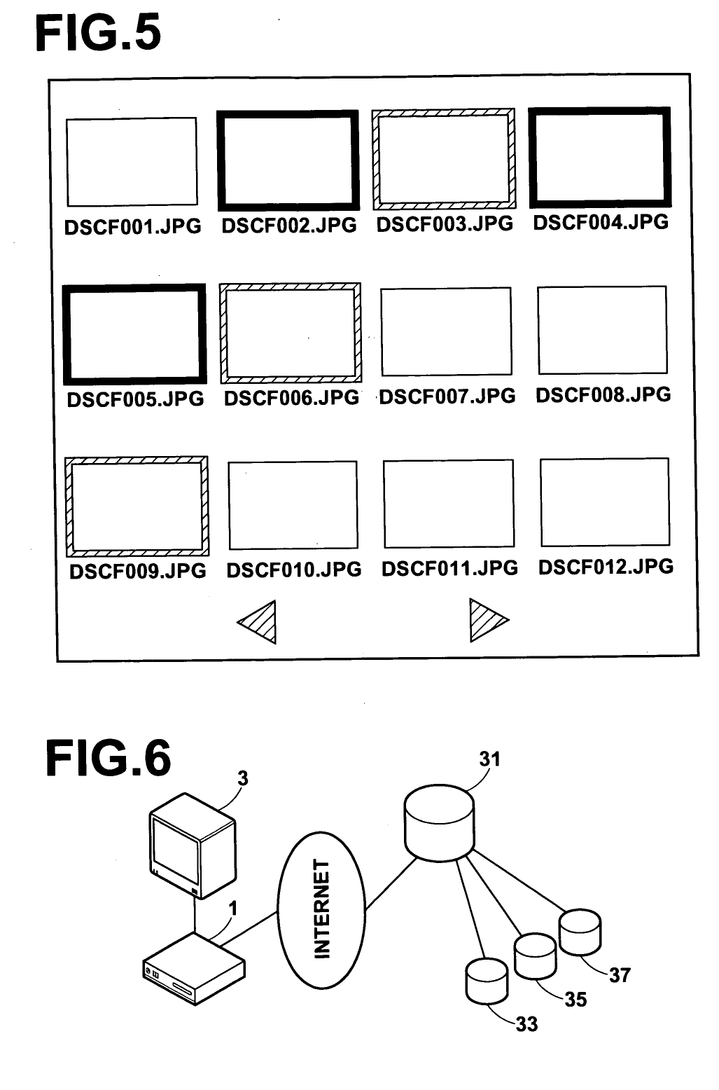

FIG. 5 shows a screen in which the catalog is displayed. As shown in FIG. 5, the image data sets DSCF001.JPG, DSCF007.JPG, DSCF008.JPG, DSCF010.JPG and the like having the degree of security that is not smaller than the threshold value Th2 are not added with any frames. The image data sets DSCF003.JPG, DSCF006.JPG, and DSCF009.JPG having the degree of security smaller than the threshold value Th2 but not smaller than the threshold value Th1 are added with the yellow frames (shown by hatched frames in FIG. 5). The image data sets DSCF002.JPG, DSCF004.JPG, and DSCF005.JPG whose degree of security is smaller than the threshold value Th1 are added with the red frames (shown by black frames in FIG. 5).

The user can understand the degree of security of the image data sets by viewing the catalog of the thumbnail images. Therefore, the user can understand that the image data sets added with the red frames need to be backed up immediately through transmission of the image data sets to the file servers 5 and 7 and/or the HDD 9 for storage thereof. For the image data sets having the yellow frames, the user can understand the necessity of backup of the image data sets by storage thereof through transmission to the file servers 5 and 7 and/or the HDD 9, although the backup is not imminent. In this manner, the user can easily carry out the backup.

In the embodiment described above, the colored frames are displayed according to the degree of security when the catalog of the thumbnail images is displayed. However, the degree of security may be displayed as numerals. Furthermore, when a list of the file names of the image data sets is displayed, the degree of security may also be displayed in a visually perceptible manner, in addition to the case of display in the catalog. For example, the file names may be displayed in different colors corresponding to the degree of security (such as red if the degree is smaller than Th1, and yellow if the degree is smaller then Th2 but not smaller than Th1). Alternatively, the numerals representing the degree may be displayed together with the file names.

In the embodiment described above, the image data sets having the degree of security not smaller than the threshold value Th2 are displayed in the catalog without any frames added thereto. However, the image data sets may be displayed in the catalog by being added with green frames representing safety.

Either one of the HDDs comprising the RAID 11 may have a failure in some cases in the embodiment described above. In such a case, the degree of security is calculated by using 0 as the reliability of the RAID 11. In this manner, the degree of security becomes smaller, and the user can immediately carry out the backup.

In the embodiment described above, the backup locations and the date of backup may be described in meta-data added to the image data sets instead of the backup list.

In the case where the information on the backup locations is described in the meta-data of the image data sets, if the image data sets are deleted in the file servers 5 and 7 and/or the HDD 9 (hereinafter collectively referred to as the servers and the like), it is preferable for the servers and the like to send information representing the deletion to all of the backup locations, by referring to the meta-data of the image data sets. In this manner, the backup locations can be deleted from the meta-data of the image data sets that have been deleted, in the respective backup locations. If necessary, the image data sets can be backed up in another one of the backup locations.

In the embodiment described above, the image data sets are backed up in the servers and the like, according to an intention of the user. However, the image data sets may be backed up at the same time the image data sets are stored in the RAID 11, through automatic transmission of the image data sets to the servers and the like.

In this embodiment, the image data sets are stored in the RAID 11. However, an HDD may be used instead of the RAID 11 so that the image data sets can be stored therein. In addition, a recordable DVD may always be inserted in the media drive 13 so that the image data sets can be backed up by storing the image data sets in the DVD at the same time of recording the image data sets in the RAID 11 or the HDD.

In the embodiment described above, the image data sets are backed up by sending the image data sets directly from the HDD recorder 1 to the file servers 5 and 7 for storage thereof. However, as shown in FIG. 6, the image data sets stored in the HDD recorder 1 may be stored in a file server 31 so that the file server 31 can back up the image data sets through transmission of the image data sets to file servers 33, 35, and 37 for storage of the image data sets therein.

In this case, the file server 31 manages the backup list. When the catalog is displayed by using the HDD recorder 1, the degree of security is calculated with reference to the backup list stored in the file server 31.

1. An image display apparatus comprising:
image storage means for storing images;
backup processing means for carrying out backup processing regarding the images; and
display control means for finding a degree of security regarding the stored images according to a degree of backup thereof and for displaying the images or file names thereof on display means in such a manner that the degree of security is visually perceptible.

2. The image display apparatus according to claim 1, wherein
the image storage means comprises a plurality of recording media and
the backup processing means carries out the backup processing by storing the images in each of the recording media.

3. The image display apparatus according to claim 1, wherein the backup processing means carries out the backup processing by sending the stored images to at least one external apparatus.

4. The image display apparatus according to claim 1, wherein the display control means finds the degree of security according to reliability of backup locations of the images and according to the number of the backup locations.

5. The image display apparatus according to claim 1, wherein the display control means causes the degree of security to be visually perceptible by adding frames having colors corresponding to the degree of security to the images.

6. The image display apparatus according to claim 1, wherein the display control means causes the degree of security to be visually perceptible by displaying the degree of security as numerals.

7. The image display apparatus according to claim 1, wherein the display control means displays a catalog of the images.

8. An image display method for an image display apparatus having image storage means for storing images and backup processing means for carrying out backup processing regarding the images, the image display method comprising the steps of:
finding a degree of security for the stored images according to a degree of backup of the images; and
displaying the images or file names thereof in such a manner that the degree of security is visually perceptible.

9. A program for causing a computer to execute an image display method in an image display apparatus having image storage means for storing images and backup processing means for carrying out backup processing regarding the images, the program comprising the steps of:
finding a degree of security for the stored images according to a degree of backup of the images; and
displaying the images or file names thereof in such a manner that the degree of security is visually perceptible.

10. A computer readable medium having the program defined in claim 9 recorded therein.
